(19) United States
(12) Patent Application Publication
(10) Pub. No.: US 2005/0216329 A1
(43) Pub. Date: Sep. 29, 2005

(54) Method for session based user evaluation of distributed content

(75) Inventors: John Hans Handy-Bosma, Cedar Park, TX (US); Kevin Holubar, Cedar Park, TX (US); Shannon James Kerlick, Cedar Park, TX (US); Dan Jeffrey Mandelstein, Austin, TX (US); Arvind Raveendranathan Nair, Bangalore (IN); Mei Yang Selvage, Austin, TX (US); Thomas Christopher Storey, Wappingers Falls, NY (US); Sudhandhira Selvan Viswanathan, Bangalore (IN)

Correspondence Address: IBM CORPORATION (RUS), C/O SIEGESMUND & ASSOCIATES, 4627 NORTH CENTRAL EXPRESSWAY, SUITE 2000, DALLAS, TX, 75206, US

(73) Assignee: International Business Machines Corporation, Armonk, NY (US)

(21) Appl. No.: 10/798,903

(22) Filed: Mar. 11, 2004

(51) Int. Cl. G06F 17/60

(52) U.S. Cl. 705/10; 705/14

(57) ABSTRACT

A method for capturing a user evaluation of distributed content comprising an Evaluation Program (EP). The user evaluation is saved with other information such as the time and date of distributed content access, the user's personal information, and the navigation path the user used to access the distributed content page. The EP creates a user session that records the user's navigation of the distributed content. The EP uses incentive programs to entice the user to rate the distributed content page. The EP gives the user the opportunity to rate distributed content if the distributed content page has a content rating window and if the user meets the minimum evaluation criteria for the distributed content page. The EP displays a content rating window allowing the user to rate the distributed content page. The EP saves the user's evaluation with the user session data and closes the user session when the user leaves the distributed content.

### FIELD OF THE INVENTION

The present invention is directed generally to a method for gathering distributed content evaluations and specifically to a method for capturing a user's real-time evaluation of distributed content pages.

### BACKGROUND OF THE INVENTION

Distributed content is a general term used to describe electronic media that is distributed to end users. Examples of distributed content include webpages and websites, dynamically generated content, cellular telephones using wireless application protocol (WAP) to serve content on the cellular telephone screen, and so forth. Other examples of distributed content are known to persons of ordinary skill in the art. Because there is a high demand for adapting distributed content to the end users' needs, distributed content administrators (administrators) are constantly seeking feedback on the distributed content pages they administer. Due to the anonymity of distributed content users, reliable user feedback regarding the distributed content pages can be difficult to obtain.

One of the problems associated with obtaining user evaluations of distributed content is that distributed content users do not consistently give feedback on the distributed content that they view or use. Often, a user will only give feedback when the user has had a particularly difficult time navigating the distributed content. While these types of comments are useful to administrators in removing distributed content that is difficult to use, they do not convey any information regarding the distributed content that is easy to use. Therefore, a need exists for a method for a user to evaluate distributed content in which the user can identify the distributed content that is difficult to use and distributed content that is easy to use.

A second problem associated with user evaluation of distributed content is that the user is sometimes presented with a single user evaluation form or survey to use in evaluating a plurality of distributed content pages. When a user evaluates a plurality of distributed content pages on a single survey, the user tends to remember more information about the most recently navigated distributed content pages and less information about the first distributed content pages that he navigated. Thus, the survey does not adequately represent the user's evaluation of the entire distributed content, but rather the user's evaluation of the distributed content pages immediately preceding the survey. A survey that weighs the user's evaluation of more recently navigated content is called a back-loaded survey. Back-loaded surveys are not preferable because they do not adequately reflect the user's evaluation of the entire distributed content. Therefore, a need exists for a method of capturing a user's evaluation of distributed content in which the user's evaluation evenly reflects the user's experience in navigation of the entire set of distributed content.

A third problem associated with user evaluation of distributed content is that sometimes the survey is presented before the user has completed his navigation of the distributed content. When the survey is placed at the end of the user's navigation of the distributed content (i.e. after user selection of service, payment, and receipt of the confirmation number), users frequently do not complete the survey. Rather than complete the survey, the majority of users choose to close the distributed content application. In order to increase the number of completed surveys, administrators position the survey so that it appears before the user has completed his navigation of the distributed content (i.e. after user selection of services but prior to payment). When a survey is completed prior to conclusion of the user navigation of the distributed content, the evaluation is said to be front-loaded. Front-loaded evaluations are not preferable because they do not capture a complete picture of the user's evaluation of the distributed content. Therefore, a need exists for a method of capturing a user's evaluation of distributed content after the user has completed his navigation of the distributed content.

In addition to the disadvantages discussed above, surveys also have another disadvantage: the survey is a standard document applied to a wide variety of distributed content users. In other words, the surveys cannot be configured for specific users in the United States, Mexico, Asia, or Europe. The prior art surveys also cannot differentiate users who view one version or type of the distributed content from users who view another version or type of distributed content. If a survey were able to differentiate between different types of users and the distributed content they view or use, then the survey could be customized for each type of user. Customizing the survey to each type of user would make the responses in the survey more meaningful. Therefore, a need exists for a method for surveying distributed content users in which the survey can be configured according to the characteristics and navigation experiences of individual users or groups of users.

Consequently, a need exists in the art for an improved method for user evaluation of distributed content. A need exists for a method in which the user can identify the distributed content that is difficult to use and distributed content that is easy to use. A need exists for a method of capturing a user's evaluation of distributed content in which the user's evaluation evenly reflects the user's experience in navigation of the entire distributed content. A need exists for a method of capturing a user's evaluation of distributed content after the user has completed his navigation of the distributed content. Finally, a need extends to a method for surveying distributed content users in which the survey can be configured for individual users.

### SUMMARY OF THE INVENTION

The present invention, which meets the needs identified above, is a method for capturing a user evaluation of distributed content. The user evaluation is saved with other information such as the time and date of the evaluation, the user's personal information, and the navigation path the user used to access the distributed content page. The software embodiment of the present invention comprises an Evaluation Program (EP) that creates a user session when a user accesses distributed content. The EP records the user's navigation of the distributed content in the user session. The EP gives the user the opportunity to rate distributed content if the distributed content page has a content rating window and if the user meets the minimum evaluation criteria for the distributed content page. The EP can be combined with various incentive programs to entice the user to rate the distributed content pages. The user also has the option to forgo rating the distributed content page, if desired. If the user decides to rate the distributed content page, the EP displays a content rating window that allows the user to rate the distributed content page. The EP saves the user's evaluation with the user session data. If the user accesses another distributed content page, the EP repeats the process described above. The EP closes the user session when the user leaves the distributed content. The EP can optionally reopen the user session when the user returns to the distributed content.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a computer network used to implement the present invention;

FIG. 2 is an illustration of a computer, including a memory and a processor, associated with the present invention;

FIG. 3 is an illustration of the logic of the Evaluation Program (EP) of the present invention;

FIG. 4 is an illustration of the user session of the present invention; and

FIG. 5 is an illustration of the content rating window of the present invention.

### DETAILED DESCRIPTION OF THE PREFERRED EMBODIMENT

As used herein, the term “computer” shall mean a machine having a processor, a memory, and an operating system, capable of interaction with a user or other computer, and shall include without limitation desktop computers, notebook computers, tablet computers, personal digital assistants (PDAs), servers, handheld computers, and similar devices.

As used herein, the term “content rating window” shall mean a graphical user interface (GUI) that allows a user to rate a distributed content page.

As used herein, the term “distributed content” shall mean electronic content distributed to a plurality of end users over a computer network. Examples of distributed content include webpages and websites, dynamically generated content, and cellular telephones using wireless application protocol (WAP) to serve content on the cellular telephone screen. Other examples of distributed content are known to persons of ordinary skill in the art.

As used herein, the term “distributed content page” shall mean a single distributed content document, file, script, view of content, or database.

As used herein, the term “evaluate” shall mean for a user to rate the distributed content page.

As used herein, the term “incentive program” shall mean a program in which a user receives miles, points, or gifts in exchange for buying, using, selecting, or evaluating a good, a service, or a distributed content page.

As used herein, the term “minimum evaluation criteria” shall mean a group of criteria that defines a type of user who may evaluate a distributed content page.

As used herein, the term “navigation” shall mean to browse, select options from, and/or click hyperlinks on a distributed content page.

As used herein, the term “user ratings” shall mean a database containing a user evaluation of a distributed content page, the version of the distributed content page, and optionally incentive gifts earned by the user for evaluating the distributed content page.

As used herein, the term “user session” shall mean a database of the user information and the user's navigation history through a distributed content page.

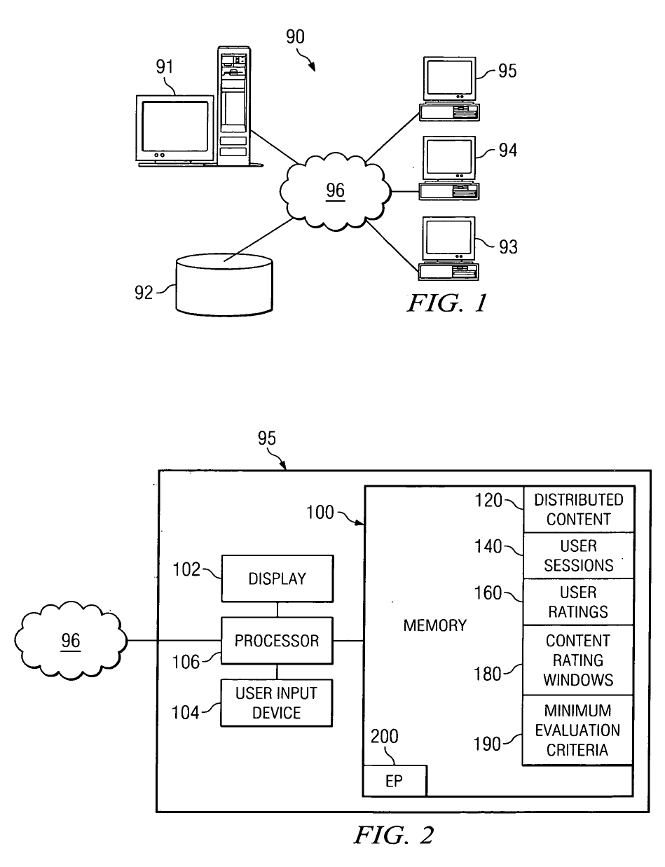

FIG. 1 is an illustration of computer network 90 associated with the present invention. Computer network 90 comprises local computer 95 electrically coupled to network 96. Local computer 95 is electrically coupled to remote computer 94 and remote computer 93 via network 96. Local computer 95 is also electrically coupled to server 91 and database 92 via network 96. Network 96 may be a simplified network connection such as a local area network (LAN) or may be a larger network such as a wide area network (WAN) or the Internet. Furthermore, computer network 90 depicted in FIG. 1 is intended as a representation of a possible operating network containing the present invention and is not meant as an architectural limitation.

The internal configuration of a computer, including connection and orientation of the processor, memory, and input/output devices, is well known in the art. The present invention may be a method, a stand alone computer program, or a plug-in to an existing computer program. Persons of ordinary skill in the art are aware of how to configure computer programs, such as those described herein, to plug into an existing computer program. Referring to FIG. 2, the methodology of the present invention is implemented on software by Evaluation Program (EP) 200. EP 200 described herein can be stored within the memory of any computer depicted in FIG. 1. Alternatively, EP 200 can be stored in an external storage device such as a removable disk, a CD-ROM, or a USB storage device. Memory 100 is illustrative of the memory within one of the computers of FIG. 1. Memory 100 also contains distributed content 120, user sessions 140, user ratings 160, content rating windows 180, and minimum evaluation criteria 190.

Distributed content 120 is electronic content distributed to a plurality of end users over a computer network. Distributed content 120 comprises a plurality of distributed content pages. Examples of distributed content include webpages and websites, dynamically generated content, and cellular telephones using wireless application protocol (WAP) to serve content on the cellular telephone screen. Other examples of distributed content are known to persons of ordinary skill in the art. Distributed content 120 contains at least one distributed content page accessible by a user. User sessions 140 are computer files that track the user's navigation history within distributed content 120. Each user session 140 contains the time and date of the user access, the user's IP address, the distributed content pages accessed by a user, the hyperlinks clicked by the user, and the user's personal information, if available. User ratings 160 contain the users' evaluations of the distributed content pages coupled with user session 140. User ratings 160 can optionally contain the incentive plan chosen by the user and/or a description of the incentives received for evaluating the distributed content page. In addition, user ratings 160 may optionally be reopened by the user to add a follow-up survey. Content ratings windows 180 are windows that allow the users to rate the distributed content pages. Minimum evaluation criteria 190 is the minimum criteria that a user must meet in order to rate distributed content 120. Minimum evaluation criteria 190 can be used to vary the content rating window 180 for different types of users. Minimum evaluation criteria 190 can include the user's personal information (i.e. if the user is male/female, the user's physical location, and so forth), the access time, the access date, the user's IP address, the selected incentive plan, and whether the user accesses the Internet via a computer, PDA, or cellular telephone. The present invention may interface with distributed content 120, user sessions 140, user ratings 160, content rating windows 180, and minimum evaluation criteria 190 through memory 100.

As part of the present invention, the memory 100 can be configured with EP 200, distributed content 120, user sessions 140, user ratings 160, content rating windows 180, and/or minimum evaluation criteria 190. Processor 106 can execute the instructions contained in EP 200. Processor 106 is also able to display data on display 102 and accept user input on user input device 104. Processor 106, user input device 104, display 102, and memory 100 are part of a computer such as local computer 95 in FIG. 1. Processor 106 can communicate with other computers via network 96.

In alternative embodiments, EP 200, distributed content 120, user sessions 140, user ratings 160, content rating windows 180, and/or minimum evaluation criteria 190 can be stored in the memory of other computers. Storing EP 200, distributed content 120, user sessions 140, user ratings 160, content rating windows 180, and/or minimum evaluation criteria 190 in the memory of other computers allows the processor workload to be distributed across a plurality of processors instead of a single processor. Further configurations of EP 200, distributed content 120, user sessions 140, user ratings 160, content rating windows 180, and/or minimum evaluation criteria 190 across various memories, such as client memory and server memory, are known by persons of ordinary skill in the art.

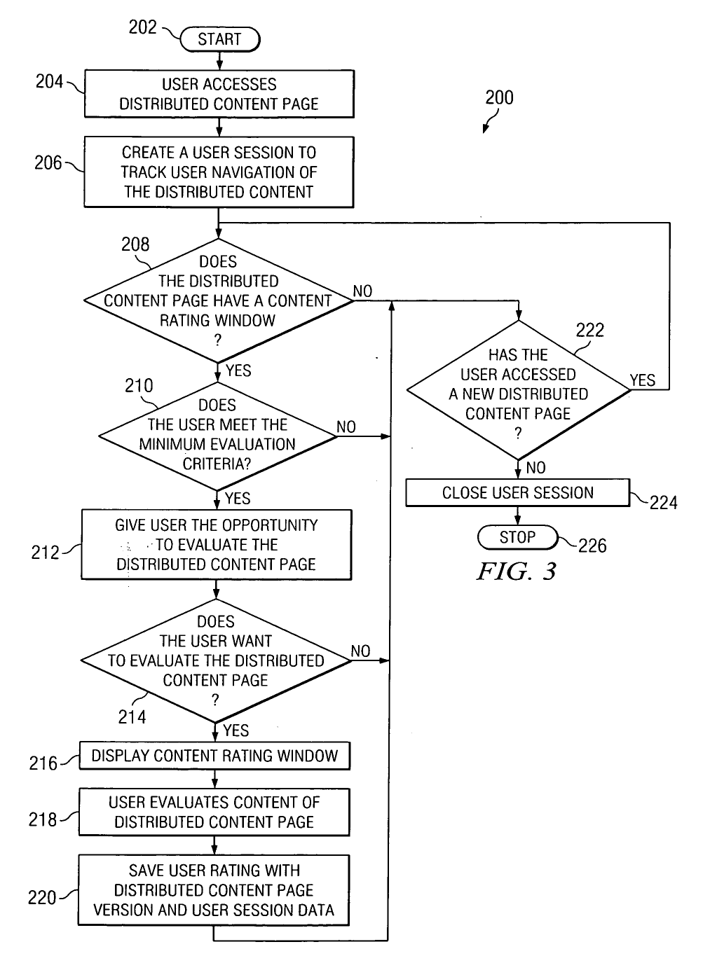

FIG. 3 is an illustration of the logic of Evaluation Program (EP) 200 of the present invention. EP 200 is a computer software program that allows a user to evaluate a plurality of distributed content pages as the user completes his navigation of each distributed content page. EP 200 starts whenever the distributed content administrator invokes EP 200 (202). A user then accesses a distributed content page (204). The distributed content page may be like one of the distributed content pages in distributed content 120 depicted in FIG. 2. EP 200 creates a user session to track the user's navigation of the distributed content pages (206). The user session may be like user session 140 depicted in FIG. 2. EP 200 then determines whether a content rating window has been created for the distributed content page (208). The content rating window may be like content rating window 180 depicted in FIG. 2. If the distributed content page does not have a content rating window, EP 200 proceeds to step 222. If the distributed content page has a content rating window, then EP 200 determines whether the user meets the minimum evaluation criteria for the content rating window (210). The minimum evaluation criteria may be like minimum evaluation criteria 190 depicted in FIG. 2. A single distributed content page may be associated with a plurality of different content rating windows, wherein each content rating window has different minimum evaluation criteria. By having different minimum evaluation criteria for each content rating window, the present invention offers a customized content rating window to specific types of users. For example, a first content rating window may ask users from Asia five questions, but a second content rating window may ask user from North America four different questions. The present invention may determine the user's location from the user's personal information or from the user's IP address. The present invention may also associate different content rating windows with different versions of the distributed content page. For example, version one of a distributed content page may have one content rating window with one set of questions and version two of a distributed content page may have a different content rating window with a different set of questions.

If the user does not meet the minimum evaluation criteria, then EP 200 proceeds to step 222. If the user meets the minimum evaluation criteria, then EP 200 gives the user an opportunity to evaluate the content of the present distributed content page (212). EP 200 can give the user the opportunity to rate the distributed content page by displaying a button that launches a content rating window. Alternatively, EP 200 can display the content rating window as a pop-up window or as a window adjacent to the distributed content page. Displaying the content rating window as a pop-up window or as an adjacent window allows the user to review the distributed content page while completing the evaluation form on the content rating window.

EP 200 can be optionally configured to offer incentives to the user in exchange for evaluating the distributed content page. Possible incentives include free gifts, points, or miles in an incentive program such as the AMERICAN EXPRESS® or the AMERICAN AIRLINES(® AADVANTAGE® incentive programs. The incentives may also be stair-stepped such that the user receives an additional gift or bonus points or miles for completing a certain number of evaluations.

EP 200 then makes a determination whether the user wants to rate the distributed content page (214). The user can indicate that he wants to rate the distributed content page by clicking the button to launch the content rating window or by rating the distributed content page on the content rating window. The user can indicate that he does not want to rate the distributed content page by not clicking the button to launch the content rating window or by closing the content rating window without evaluating the content. If the user does not want to rate the distributed content page, EP 200 proceeds to step 222. If the user wants to rate the distributed content page, then EP 200 displays the content rating window, if not already displayed (216). The present invention does not need to display the content rating window if the content rating window was displayed as part of step 212. The user then rates the present distributed content page (218). In evaluating the distributed content page, the user completes a user rating file by answering a plurality of questions regarding the distributed content page. The user ratings file may be like user ratings 160 depicted in FIG. 2. The user has the option of entering a message in the comments area of the content rating window. If desired, the user can save the user rating file in memory and access the user rating file at a later date. The user can complete his user rating file via email, web browser, telephone, or any other communicative means. Persons of ordinary skill in the art are aware of how to access a computer file, such as a user rating file, via email, web browser, telephone, and other communicative means. EP 200 then saves the user rating file with a copy of the distributed content page and the user session data (220). EP 200 then proceeds to step 222.

At step 222, EP 200 then determines whether the user has accessed a new distributed content page (222). If the user has accessed a new distributed content page, then EP 200 returns to step 208. If the user has not accessed a new distributed content page, then EP 200 closes the user session and saves the user session in the user sessions file (224). EP 200 then ends (226). In an alternative embodiment, when the user returns to the distributed content, EP 200 reopens the user session and continues to track the user's access throughout the distributed content. Maintaining a single user session for a single user allows the present invention to develop a more accurate history of a specific user's navigation through the distributed content.

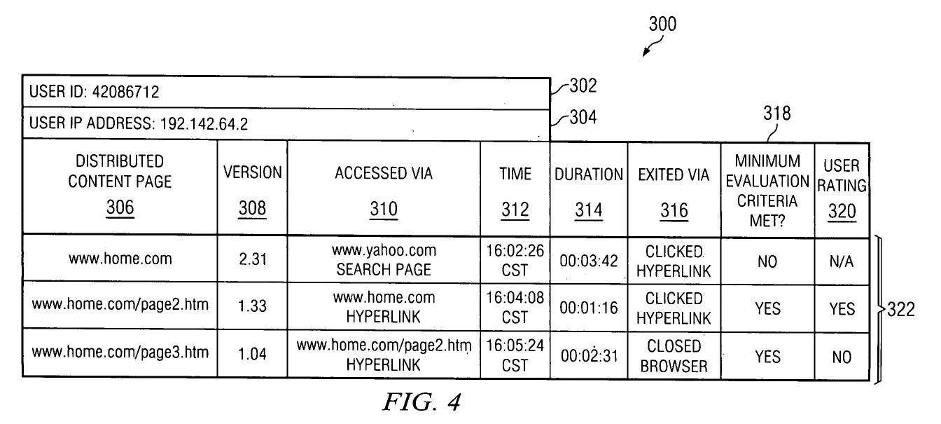

FIG. 4 is an illustration of one embodiment of user session 300. User session 300 may be like user sessions 140 in FIG. 2. User session 300 comprises user ID 302, user IP address 304, distributed content page 306, version 308, accessed via 310, time 312, duration 314, exited via 316, minimum evaluation criteria met 318, user rating 320, and data 322. User ID 302 identifies the specific user and may optionally reference the user's personal information if such information is stored in a database associated with the present invention. User IP address 304 identifies the IP address for the user. Distributed content page 306 is the distributed content page that the user accessed. Version 308 is the version of distributed content page 306. Accessed via 310 is the path by which the user accessed distributed content page 306. Time 312 is the time that the user accessed distributed content page 306. Duration 314 is the total time the user spent browsing distributed content page 306. Exited via 316 is the path by which the user exited distributed content page 306. Minimum evaluation criteria met 318 is a Boolean field that defines whether the user met minimum evaluation criteria 190 (see FIG. 2) for the distributed content page. User rating 320 is a Boolean field that defines whether the user completed a user rating 160 for the distributed content page. User rating 160 may be like user rating 160 in FIG. 2. Data 322 is the user's navigation history through the distributed content associated with the present invention.

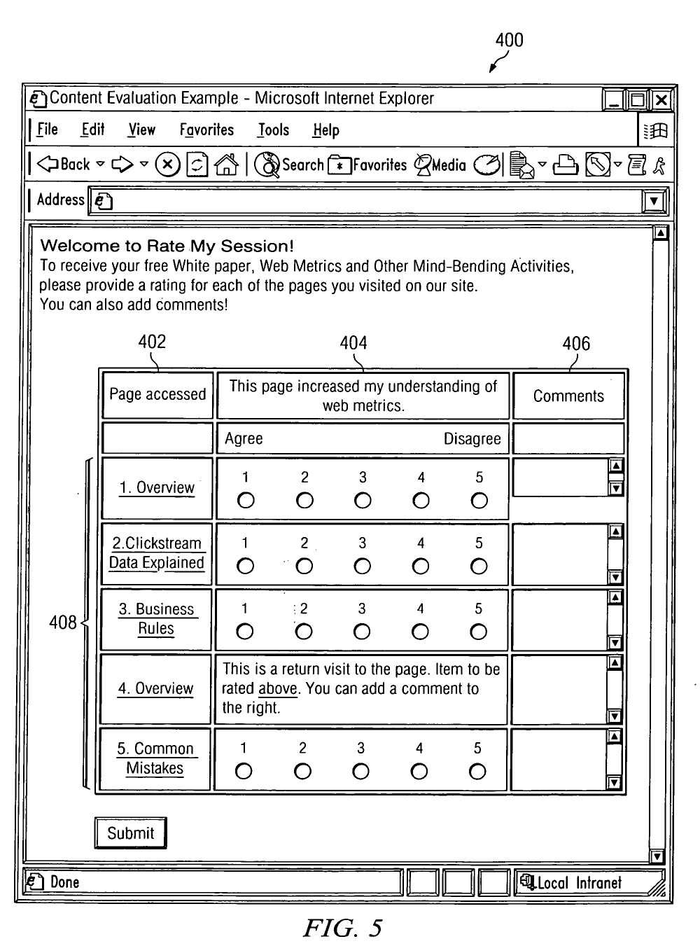

FIG. 5 is an illustration of one embodiment of content rating window 400. Content rating window 400 may be like content rating window 180 in FIG. 2. Content rating window 400 allows the user to rate distributed content while the user is navigating the distributed content page. Content rating window 400 asks the user a series of questions 402. The user enters the answers 404 to the questions 402. The user may also enter comments 406, if desired. The user may click one of the hyperlinks 408 if the user desires to review an aspect of the distributed content page prior to answering questions 402. The user may submit the evaluation using the “Submit” button.

The configuration of EP 200, distributed content 120, user sessions 140, user ratings 160, content rating windows 180, and minimum evaluation criteria 190 of the present invention offers many advantages over the prior art solutions. For example, because user ratings 160 are saved in conjunction with specific information about the user in user session 140, user ratings 160 may be categorized by any of the fields in user session 140 or user ratings 160. The present invention also resolves the problem of front-loaded and back-loaded evaluations by gathering information within the context of a complete visit to the distributed content page by the user. The present invention provides the user with an opportunity to evaluate a plurality of distributed content pages within a plurality of different types of distributed content. Through the incentive program, the present invention encourages user evaluation of the distributed content pages. The present invention can be easily implemented with existing incentive programs. The users are able to refresh their memory about the distributed content page by flipping back and forth between the distributed content page and content rating window 180 while evaluating the distributed content page.

The present invention is also extensible. The invention allows the administrators to analyze the duration data in user session 140 to differentiate between distributed content page requests created by stray mouse clicks and deliberate distributed content page requests. The present invention allows the user to launch and re-launch content rating window 180 when desired. The present invention can be configured to allow a user to update his evaluation by reopening his user rating 160. The user can then complete his users rating 160 via email, web browser, telephone, or any other communicative means. The present invention allows for integration of a company's complaint management, support, and similar systems. Finally, the present invention can be cross-referenced with other survey data.

With respect to the above description, it is to be realized that the optimum dimensional relationships for the parts of the invention, to include variations in size, materials, shape, form, function, manner of operation, assembly, and use are deemed readily apparent and obvious to one of ordinary skill in the art. The present invention encompasses all equivalent relationships to those illustrated in the drawings and described in the specification. The novel spirit of the present invention is still embodied by reordering or deleting some of the steps contained in this disclosure. The spirit of the invention is not meant to be limited in any way except by proper construction of the following claims.

1. A method for gathering a plurality of evaluations from a plurality of users who evaluate a distributed content page using a content rating window; wherein the content rating window is based on the characteristics of each user.

2. The method of claim 1 comprising:
installing an evaluation program on a computer;
wherein the evaluation program performs steps comprising:
accepting access by one of the plurality of users to the distributed content page;
creating a user session;
accepting a user evaluation of the distributed content page; and
saving the user evaluation as a user rating, wherein the user rating is cross-referenced with the user session.

3. The method of claim 2 wherein the user session tracks the user's navigation of a plurality of the distributed content pages.

4. The method of claim 3 wherein the evaluation program further performs steps comprising:
determining whether the distributed content page is associated with the content rating window;
responsive to the determination that the distributed content page is associated with the content rating window, determining whether the user meets a minimum evaluation criteria for the content rating window;
responsive to the determination that the user meets the minimum evaluation criteria for the content rating window, giving the user the opportunity to evaluate the distributed content page;
determining whether the user desires to evaluate the distributed content page; and
responsive to the determination that the user desires to evaluate the distributed content page, displaying the content rating window.

5. The method of claim 4 wherein the evaluation program further performs steps comprising:
responsive to the determination that the distributed content page is not associated with the content rating window, determining whether the user has accessed a different distributed content page.

6. The method of claim 5 wherein the evaluation program further performs steps comprising:
responsive to the determination that the user does not meet the minimum evaluation criteria for the content rating window, determining whether the user has accessed the different distributed content page.

7. The method of claim 6 wherein the evaluation program further performs steps comprising:
responsive to the determination that the user does not desire to evaluate the distributed content page, determining whether the user has accessed the different distributed content page.

8. The method of claim 7 wherein the evaluation program further performs steps comprising:
responsive to the determination that the user has accessed the different distributed content page, repeating the steps in claim 7.

9. The method of claim 8 wherein the evaluation program further performs steps comprising:
responsive to the determination that the user has not accessed the different distributed content page, closing the user session.

10. The method of claim 9 wherein the user is offered an incentive for evaluating the distributed content page.

11. The method of claim 10 wherein the incentive is gifts, points, or miles.

12. The method of claim 11 wherein the incentive is tracked in the user rating.

13. The method of claim 12 wherein the user saves the user rating in a memory and completes the user rating at a later date.

14. The method of claim 13 wherein the user rating may be categorized by any of the fields in the user session or the user rating.

15. The method of claim 14 wherein the user completes the user rating by email, web browser, or telephone.

16. The method of claim 15 wherein the user rating gathers evaluative information from the user based on the user's complete navigation of the plurality of the distributed content pages.

17. The method of claim 16 wherein the user rating allows the user to evaluate the plurality of the distributed content pages.

18. The method of claim 17 wherein the user reviews the distributed content page simultaneous with reviewing the content rating window.

19. The method of claim 18 wherein distributed content administrator can distinguish between an accidental distributed content page request and an intentional distributed content page request by analyzing a duration data in the user session.

20. The method of claim 19 wherein the distributed content page is a webpage.

21. The method of claim 20 wherein the distributed content page is displayed on a portable electronic device.

22. A program product operable on a computer comprising:
a computer-usable medium;
wherein the computer usable medium comprises instructions for a computer to perform steps comprising:
accepting access by a user to a distributed content page;
creating a user session;
accepting a user evaluation of the distributed content page; and
saving the user evaluation as a user rating, wherein the user rating is cross-referenced with the user session.

23. The program product of claim 22 wherein the user session tracks the user's navigation of a plurality of the distributed content pages.

24. The program product of claim 22 wherein the steps further comprise:
determining whether the distributed content page is associated with a content rating window;
responsive to the determination that the distributed content page is associated with the content rating window, determining whether the user meets a minimum evaluation criteria for the content rating window;
responsive to the determination that the user meets the minimum evaluation criteria for the content rating window, giving the user the opportunity to evaluate the distributed content page;
determining whether the user desires to evaluate the distributed content page; and
responsive to the determination that the user desires to evaluate the distributed content page, displaying the content rating window.

25. The program product of claim 24 wherein the content rating window is based on the characteristics of each user.

26. The program product of claim 24 wherein the steps further comprise:
responsive to the determination that the distributed content page is not associated with the content rating window, determining whether the user has accessed a different distributed content page.

27. The program product of claim 24 wherein the steps further comprise:
responsive to the determination that the user does not meet the minimum evaluation criteria for the content rating window, determining whether the user has accessed the different distributed content page.

28. The program product of claim 24 wherein the steps further comprise:
responsive to the determination that the user does not desire to evaluate the distributed content page, determining whether the user has accessed the different distributed content page.

29. The program product of claim 24 wherein the steps further comprise:
responsive to the determination that the user has accessed the different distributed content page, repeating the steps in claim 24.

30. The program product of claim 24 wherein the steps further comprise:
responsive to the determination that the user has not accessed the different distributed content page, closing the user session.

31. The program product of claim 24 wherein the user is offered an incentive for evaluating the distributed content page.

32. The program product of claim 31 wherein the incentive is gifts, points, or miles.

33. The program product of claim 31 wherein the incentive is tracked in the user rating.

34. The program product of claim 24 wherein the user saves the user rating in a memory and completes the user rating at a later date.

35. The program product of claim 24 wherein the user rating may be categorized by any of the fields in the user session or the user rating.

36. The program product of claim 24 wherein the user completes the user rating by email, web browser, or telephone.

37. The program product of claim 24 wherein the user rating gathers evaluative information from the user based on the user's complete navigation of a plurality of the distributed content pages.

38. The program product of claim 24 wherein the user rating allows the user to evaluate a plurality of the distributed content pages.

39. The program product of claim 24 wherein the user reviews the distributed content page simultaneous with reviewing the content rating window.

40. The program product of claim 24 wherein distributed content administrator can distinguish between an accidental distributed content page request and an intentional distributed content page request by analyzing a duration data in the user session.

41. The program product of claim 24 wherein the distributed content page is a webpage.

42. The program product of claim 24 wherein the distributed content page is displayed on a portable electronic device.

43. An apparatus for gathering a plurality of evaluations from a plurality of users who evaluate a distributed content page using a content rating window, the apparatus comprising:
means for accepting access by one of the plurality of users to the distributed content page;
means for creating a user session;
means for accepting a user evaluation of the distributed content page;
means for saving the user evaluation as a user rating, wherein the user rating is cross-referenced with the user session;
wherein the user session tracks the user's navigation of the distributed content page;
means for determining whether the distributed content page is associated with the content rating window;
responsive to the determination that the distributed content page is associated with the content rating window, means for determining whether the user meets a minimum evaluation criteria for the content rating window;
responsive to the determination that the user meets the minimum evaluation criteria for the content rating window, means for giving the user the opportunity to evaluate the distributed content page;
means for determining whether the user desires to evaluate the distributed content page;
responsive to the determination that the user desires to evaluate the distributed content page, means for displaying the content rating window;
wherein the content rating window is based on the characteristics of each user;
responsive to the determination that the distributed content page is not associated with the content rating window, means for determining whether the user has accessed a different distributed content page;
responsive to the determination that the user does not meet the minimum evaluation criteria for the content rating window, means for determining whether the user has accessed the different distributed content page;
responsive to the determination that the user does not desire to evaluate the distributed content page, means for determining whether the user has accessed the different distributed content page;
responsive to the determination that the user has accessed the different distributed content page, means for repeating the steps herein;
responsive to the determination that the user has not accessed the different distributed content page, means for closing the user session;
wherein the user is offered an incentive for evaluating the distributed content page;
wherein the user saves the user rating in a memory and completes the user rating at a later date;
wherein the user rating may be categorized by any of the fields in the user session or the user rating;
wherein the user completes the user rating by email, web browser, or telephone;
wherein the user rating gathers evaluative information from the user based on the user's complete navigation of a plurality of the distributed content pages;
wherein the user rating allows the user to evaluate the plurality of the distributed content pages;
wherein the user reviews the distributed content page simultaneous with reviewing the content rating window;
wherein distributed content administrator can distinguish between an accidental distributed content page request and an intentional distributed content page request by analyzing a duration data in the user session;
wherein the distributed content page is a webpage; and
wherein the distributed content page is displayed on a portable electronic device.

44. The apparatus of claim 43 wherein the incentive is gifts, points, or miles.

45. The apparatus of claim 43 wherein the incentive is tracked in the user rating.
